(19) United States
(12) Patent Application Publication
(10) Pub. No.: US 2016/0039039 A1
(43) Pub. Date: Feb. 11, 2016

(54) ALUMINUM RESISTANCE SPOT WELDING TIP AND METHOD OF MAKING THE SAME

(71) Applicants: Paul C. Edwards, II, Marysville, OH (US); Eric Flewelling, Columbus, OH (US)

(72) Inventors: Paul C. Edwards, II, Marysville, OH (US); Eric Flewelling, Columbus, OH (US)

(73) Assignee: HONDA MOTOR CO., LTD., Tokyo (JP)

(21) Appl. No.: 14/452,280

(22) Filed: Aug. 5, 2014

(51) Int. Cl. B23K 11/36; B23K 11/18; B23K 11/30

(52) U.S. Cl. CPC B23K 11/366; B23K 11/3009; B23K 11/185

(57) ABSTRACT

An electrical resistance spot welding tip for joining a plurality of aluminum alloy workpieces includes a cylindrical body extending along a central axis defined through the body between a first end and an opposing second end of the cylindrical body. A spherically domed central region is formed at the first end of the cylindrical body. The spherically domed central region has an outer boundary defining a diameter of the spherically domed central region. An annular outer ring is positioned coaxially about the spherically domed central region. The annular outer ring has an end surface defined in a plane perpendicular to the central axis. A distance between a point on the spherically domed central region defined at the central axis and the end surface of the annular outer ring is dependent on a thickness of each of the plurality of aluminum alloy workpieces.

### BACKGROUND

The subject matter disclosed herein relates to aluminum resistance spot welding and, more particularly, to an aluminum resistance spot welding tip and a method of making the welding tip.

Spot welding is a commonly used technique for joining various metallic parts together. In particular, spot welding is a resistance welding technique that applies a welding current and clamping force over a period of time to a small area (i.e., a “spot”) of metal parts to be welded together, such as two sheets of metal. Heat from the welding current and pressure from the clamping force between two opposing electrodes that clamp onto the small area is concentrated on the small area. During welding, a nugget of molten metal is quickly created between the sheets of metal such that when the welding current is removed and the nugget cools, the parts are joined.

Spot welding is widely used in various manufacturing industries, including assembling vehicle structures in the automobile industry. For instance, spot welding is used for joining different sections of an automobile body, e.g., side panels to a roof panel. Spot welding is also implemented in the creation of stack-ups or “stacks” of sheet metal panels, e.g., door panels, in which two or more pieces of sheet metal are stacked and welded together to produce reinforced areas in the automobile body. The materials used in such stacks may have the same or different thicknesses and/or compositions.

In one aspect, aluminum has become increasingly used in car body parts for its lightweight characteristics that provide for improved driving performance and fuel economy. Resistance spot welding of aluminum is a leading technique for assembling such car body parts. However, aluminum has a relatively high electrical conductivity and a relatively high thermal conductivity that causes much of the heat generated in aluminum workpieces to dissipate through the workpieces. As such, resistance spot welding of aluminum requires significantly high current flow in order to achieve sufficient weld strength and weld performance.

The difficulties associated with aluminum resistance spot welding include, for instance, a short transition period between melting and expulsion, whereby liquid metal bursts and is lost from a weld nugget formation. If expulsion occurs, a total thickness of the joint may be reduced, and when combined with the cavity, the resultant joint may fall below process standards. Further, resistance welding electrodes are typically made of copper alloys which permit good current flow until resistance is encountered at the welding parts, which causes heat to build up and the welding parts to melt. However, an interfacial resistance (“I/F resistance”) between copper and aluminum is similar to the I/F resistance between aluminum and aluminum. In an effort to address the above-noted concerns, welding tips having concentric ridges have been designed. However, these conventional welding tips are often fragile and offer limited welding operations. An improved welding tip and method for performing aluminum resistance spot welding is desired.

### SUMMARY

In one aspect, an electrical resistance spot welding tip for joining a plurality of aluminum alloy workpieces is provided. The electrical resistance spot welding tip includes a cylindrical body extending along a central axis defined through the body between a first end and an opposing second end of the cylindrical body. A spherically domed central region is formed at the first end of the cylindrical body. The spherically domed central region has an outer boundary defining a diameter of the spherically domed central region. An annular outer ring is positioned coaxially about the spherically domed central region. The annular outer ring has an end surface defined in a plane perpendicular to the central axis. A distance along the central axis between a point on the spherically domed central region defined at the central axis and the end surface of the annular outer ring is dependent on a thickness of each of the plurality of aluminum alloy workpieces.

In another aspect, an electrical resistance spot welding electrode for joining a plurality of aluminum alloy workpieces is provided. The electrical resistance spot welding electrode includes a welding tip having a cylindrical body extending along a central axis defined through the cylindrical body between a first end and an opposing second end of the cylindrical body. A spherically domed central region is formed at the first end of the cylindrical body. The spherically domed central region has an outer boundary defining a diameter of the spherically domed central region. An annular outer ring is positioned coaxially about the spherically domed central region. The annular outer ring has an end surface defined in a plane perpendicular to the central axis. A distance along the central axis between a point on the spherically domed central region defined at the central axis and the end surface of the annular outer ring is dependent on a thickness of each of the plurality of aluminum alloy workpieces.

In yet another aspect, a method for making an electrical resistance spot welding tip for joining a plurality of aluminum alloy workpieces is provided. The method includes forming a spherically domed central region at a first end of a cylindrical body extending along a central axis defined through the cylindrical body between the first end and an opposing second end of the cylindrical body. An annular outer ring is positioned coaxially about the spherically domed central region. The annular outer ring has an end surface defined in a plane perpendicular to the central axis at a distance along the central axis from a point on the spherically domed central region defined at the central axis dependent on a thickness of each of the plurality of aluminum alloy workpieces.

### BRIEF DESCRIPTION OF THE DRAWINGS

FIG. 1 is a schematic view of an exemplary electrical resistance spot welding apparatus;

FIG. 2 is a cross-sectional view of a welding nugget joining two workpieces together;

FIG. 3 is a perspective view of an exemplary welding tip according to one embodiment of the present disclosure;

FIG. 4 is a top view of the welding tip shown in FIG. 3;

FIG. 5 is a cross-sectional view of the welding tip shown in FIGS. 3 and 4 taken along sectional line A-A shown in FIG. 4;

FIG. 6 is a portion of the cross-sectional view of the welding tip shown in FIG. 5;

FIG. 7 is a perspective view of an exemplary welding tip according to one embodiment of the present disclosure;

FIG. 8 is a top view of the welding tip shown in FIG. 7;

FIG. 9 is a cross-sectional view of the welding tip shown in FIGS. 7 and 8 taken along sectional line A-A shown in FIG. 8;

FIG. 10 is a portion of the cross-sectional view of the welding tip shown in FIG. 9;

FIG. 11 is a perspective view of an exemplary welding tip according to one embodiment of the present disclosure;

FIG. 12 is a top view of the welding tip shown in FIG. 11;

FIG. 13 is a cross-sectional view of the welding tip shown in FIGS. 11 and 12 taken along sectional line A-A shown in FIG. 12;

FIG. 14 is a portion of the cross-sectional view of the welding tip shown in FIG. 13; and

FIG. 15 is a diagram of an exemplary method for forming an electrical resistance spot welding tip.

Other aspects and advantages of certain embodiments will become apparent upon consideration of the following detailed description, wherein similar structures have similar reference numerals.

### DETAILED DESCRIPTION

The embodiments described herein overcome difficulties associated with conventional electrical resistance spot welding electrodes and welding tips by providing a welding tip that is configured to provide a specific indent and to use mechanical focusing of the welding current to support an optimized nugget growth over a wide range of material thicknesses. In one embodiment, the described welding tip can withstand off angle welding, such as 3° off angle welding, as well as provide improved gap welding, reduced tip sticking, and reduced scrap rates. Also described herein is a method for forming or making an electrical resistance spot welding tip for joining a plurality of aluminum alloy workpieces.

Additionally, one embodiment described herein is directed to a method of using the disclosed welding tip. The welding tip includes a spherically domed central region having a suitable radius of curvature indents at a squeeze force that is appropriate for stacking the metal sheets together. A current flow is provided to allow a welding nugget to start and provide a full indentation. The welding nugget continues to form under application of the high current flow, which causes the size of the contact surface to increase during welding. As a result, an annular outer ring of the welding tip touches the workpiece and thereby reduces the weld current density and expands the I/F diameter of the current, whereupon the welding nugget reaches an optimal size. The weld current is removed and the full indentation can be measured to determine the quality of the nugget.

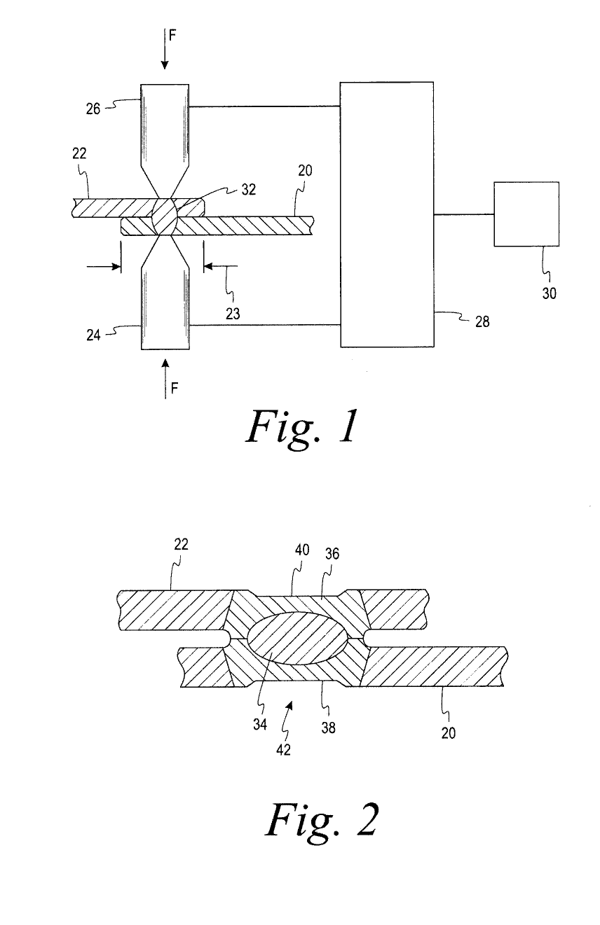

Referring initially to FIGS. 1 and 2, aluminum resistance spot welding is a method for joining a first sheet or workpiece 20 to a second sheet or workpiece 22 disposed on the first workpiece 20 having a suitable overlap zone 23. First workpiece 20 and second workpiece 22 are joined using two electrodes, namely a first electrode 24 and an oppositely positioned second electrode 26 as shown in FIG. 1. First electrode 24 and second electrode 26 are operatively coupled to a control system 28 including a transformer connected to an electricity source 30. An electric current having a current intensity Ic is passed through first electrode 24 and second electrode 26 during a limited time at a contact zone 32 of the workpieces situated between first electrode 24 and second electrode 26. The passage of the electric current through contact zone 32 causes the metal to melt to form a molten core 34 surrounded by an outer zone 36 forming indentations 38 and 40 due to a pressure force F exerted on each workpiece by the respective electrode. After the passage of the electric current, the molten core 34 solidifies and ensures a connection between the two workpieces. One or more spot welds are produced along the overlap zone to join the two workpieces. A weld nugget 42 is formed including molten core 34 and outer zone 36.

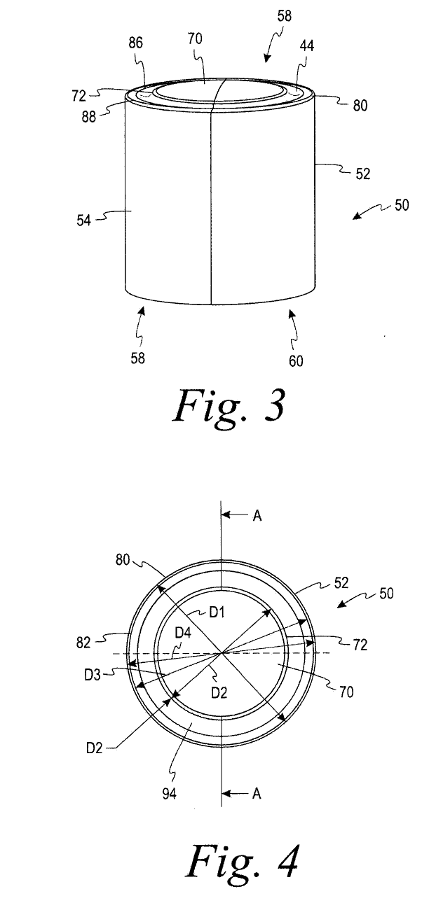

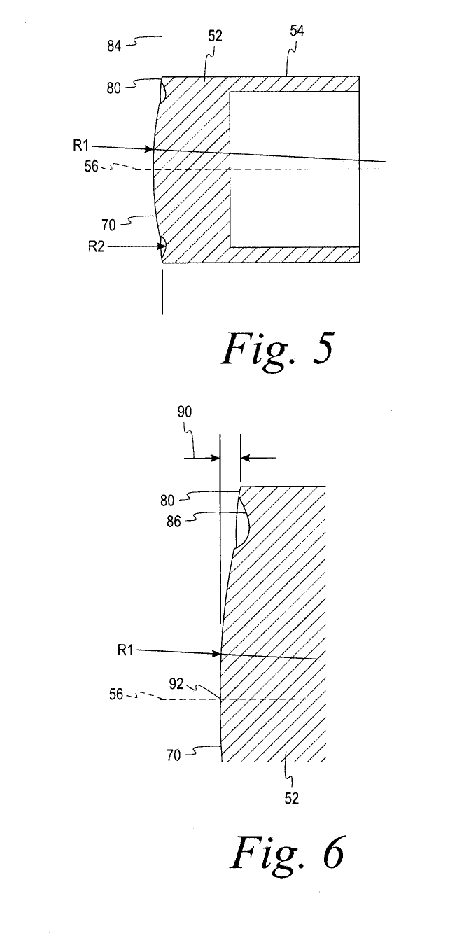

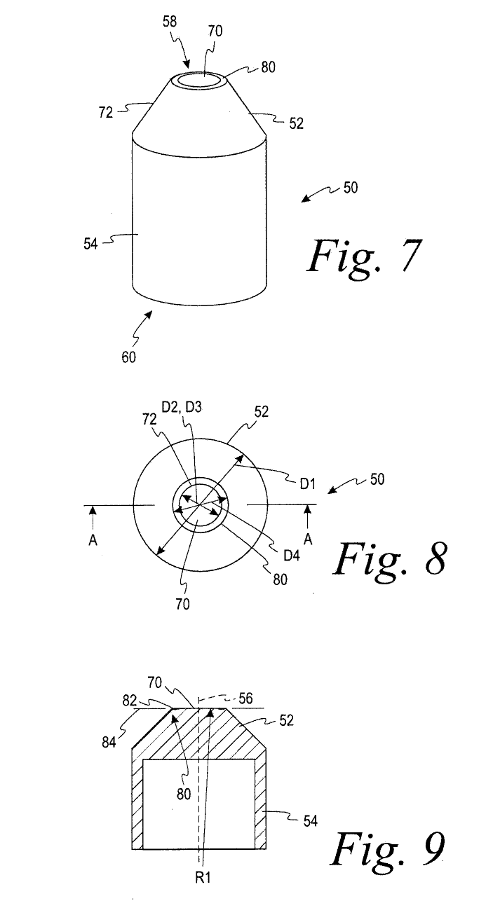

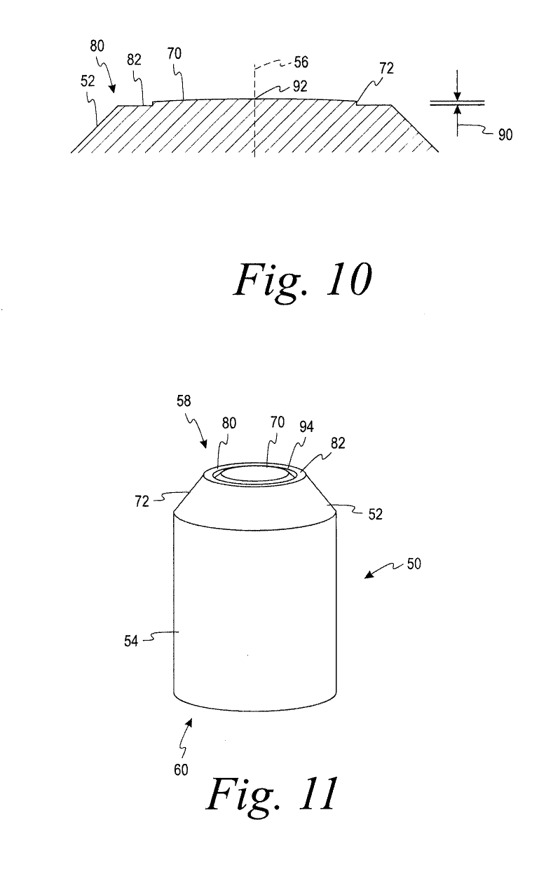

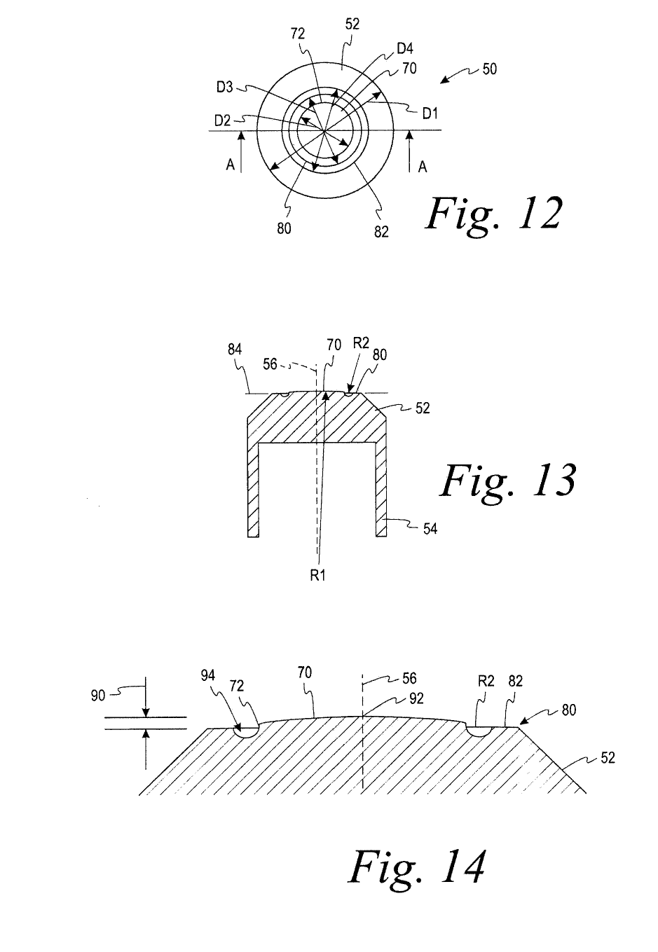

FIGS. 3-14 show exemplary electrical resistance spot welding electrodes 50 for welding aluminum alloy workpieces together. In one embodiment, electrical resistance spot welding electrode 50 includes a welding tip 52 having a cylindrical body 54 extending along a central axis 56, as shown in FIGS. 5, 9, and 13, defined through cylindrical body 54 between a first end 58 and an opposing second end 60 of cylindrical body 54. As shown, for example, in FIGS. 7-14, in certain embodiments cylindrical body 54 is tapered at first end 58. Cylindrical body 54 may have any suitable outer diameter D1, as shown in FIGS. 4, 8, and 12. For example, in certain embodiments as described herein, cylindrical body 54 may have an outer diameter D1 between 18.0 millimeters (mm) and 20.0 mm or, more specifically, approximately 19.0 mm. In alternative embodiments, D1 may be less than 18.0 mm or greater than 20 mm.

Welding tip 52 includes a spherically domed central region 70 formed at first end 58 of cylindrical body 54. Spherically domed central region 70 has an outer boundary, such as a circumferential wall 72, defining a diameter D2 of spherically domed central region 70. According to embodiments as described herein, for example, diameter D2 of spherically domed central region 70 is between 4.0 mm and 10.0 mm or, more specifically, between 6.0 mm and 8.0 mm. In a particular embodiment, diameter D2 as shown in FIG. 7 is 6.0 mm, and, in a particular alternative embodiment, diameter D2 as shown in FIG. 11 is 8.0 mm. Further, referring to FIGS. 5, 9, and 13, according to embodiments as described herein, for example, spherically domed central region 70 has a radius of curvature R1 between 40.0 mm and 80.0 mm or, more specifically, between 40.0 mm and 50.0 mm, or, even more specifically, 50.0 mm. The spherical domed shape allows current to flow out in a diameter greater than diameter D2. For example, in one embodiment, D2 is 6.0 mm and a diameter of current flow between first electrode 24 and second electrode 26 is greater than 6.0 mm or, more specifically, greater than 7.0 mm, or, even more specifically, 8.0 mm or greater.

An annular outer ring 80 extends from first end 58 and is positioned coaxially about spherically domed central region 70. Annular outer ring 80 has an end surface 82 defined in a plane 84 perpendicular to central axis 56. As shown in FIGS. 3 and 4, for example, end surface 82 of annular ring 80 is defined between an inner edge 86 defining an inner diameter D3 of annular ring 80 and a concentric outer edge 88 defining an outer diameter D4 of annular ring 80. In certain embodiments, D4 generally corresponds with outer diameter D1 of cylindrical body 54. As described herein, end surface 82 has a width in plane 84 defined between inner diameter D3 and outer diameter D4 of annular ring 80 between 0.50 mm and 2.50 mm or, more specifically, between 1.0 mm and 2.0 mm, or, even more specifically, between 1.0 mm and 1.5 mm. In certain embodiments, the width of end surface 82 in plane 84 is proportional to diameter D2 of spherically domed central region 60. In certain embodiments, a density of current flow through annular outer ring 80 is identical to or similar to a density of current flow through spherically domed central region 70. Further, in certain embodiments, end surface 82 has an area equal to 25% to 90% of a total surface area of spherically domed central region 70 or, more specifically, between 65% and 85%.

According to the embodiments described herein, a distance 90 shown in FIGS. 6, 10, and 14, along or parallel to central axis 56 between a point 92 defined on spherically domed central region 70 at central axis 56 and end surface 82 of annular outer ring 80 is dependent, at least in part, on a total thickness of the aluminum alloy workpieces to be joined. In certain aspects, the total thickness of the aluminum alloy workpieces to be joined determines the locus for nugget development and a total allowable indentation. As shown, for example, in FIGS. 6, 10, and 14, point 92 defines a distal limit of spherically domed central region 70. Distance 90 may also be described herein as a height of domed central region 70 with respect to end surface 82.

In particular embodiments, for example, as shown in FIGS. 3 and 11, welding tip 52 of electrical resistance spot welding electrode 50 also includes an annular channel 94 formed between the outer boundary of spherically domed central region 70 and end surface 82, for example, inner edge 86 of end surface 82 defining an inner diameter D3 of annular ring 80. In this embodiment, annular channel 94 facilitates providing a visual indication of a suitable spot weld. In certain embodiments as described herein, for example, annular channel 94 has a width between diameter D2 of spherically domed central region 70 and inner diameter D3 of annular ring 80 between 0.050 mm and 0.200 mm or, more specifically, between 0.05 mm and 0.15 mm, or, even more specifically, between 0.10 mm and 0.15 mm. In one embodiment, annular channel 94 has a radius R2 less than 0.5 mm or, more specifically, between 0.1 mm and 0.5 mm, or, even more specifically, between 0.2 mm and 0.4 mm.

As described above, distance 90 between point 92 on spherically domed central region 70 at central axis 56 and end surface 82 of annular outer ring 80 is dependent on a thickness of each of the aluminum alloy workpieces that are to be joined. In one embodiment, distance 90 between point 92 is between 0.025 mm and 0.15 mm or, more specifically, between 0.050 mm and 0.100 mm. In a particular embodiment, a radius of spherically domed central region 70 is multiplied by 0.015 to arrive at distance 90, wherein a minimum distance 90 is 0.01 mm and a maximum distance 90 is 0.025 mm.

Referring further to FIGS. 7-10, in one embodiment, to join aluminum alloy workpieces each having a thickness less that 1.5 mm, diameter D2 of spherically domed central region 70 is 6.0 mm. Distance 90 between point 92 on spherically domed central region 70 at central axis 56 and end surface 80 of annular outer ring 80 is less than 0.100 mm. In a particular embodiment, distance 90 is 0.050 mm.

Referring further to FIGS. 11-14, in an alternative embodiment, to join aluminum alloy workpieces each having a thickness greater than 1.5 mm, diameter D2 of spherically domed central region 70 is 8.0 mm. In this embodiment, distance 90 between point 92 and end surface 80 is less than 0.250 mm. In a particular embodiment, distance 90 is 0.100 mm. As described herein, based, at least in part on the thickness of the workpieces to be joined, distance 90 is proportional to diameter D2 of spherically domed central region 70 to facilitate formation of the welding nugget while reducing or eliminating hot cracking.

One embodiment of a method for using welding tip 52 includes applying a pressure force or squeeze force to spherically domed central region 70 having a suitable radius of curvature to provide an indentation appropriate for stacking the metal sheets together. A current flow is provided to allow a welding nugget to start forming at a contact zone and provide a full indentation. The welding nugget continues to form under application of the high current flow, which causes the size of the contact surface to increase during welding. As a result, annular outer ring 80 of welding tip 52 contacts the respective workpiece and thereby reduces the weld current density and expands the I/F diameter of the current, whereupon the welding nugget reaches an optimal size. The weld current is removed and the full indentation can be measured to determine the quality of the nugget.

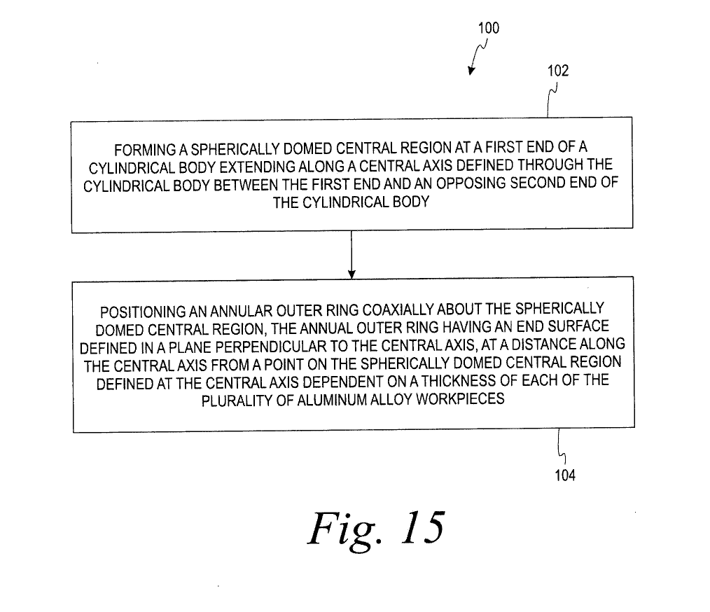

An exemplary method 100 according to one embodiment for forming an electrical resistance spot welding tip 52 for joining aluminum alloy workpieces is illustrated in FIG. 15. The method includes forming 102 a spherically domed central region 70 at first end 58 of cylindrical body 54 extending along central axis 56 defined through cylindrical body 54 between first end 58 and second end 60 of cylindrical body 54. In a particular embodiment, forming spherically domed central region 70 at first end 58 of cylindrical body 54 includes forming an outer boundary of spherically domed central region 70 having diameter D2 between 4.0 mm and 10.0 mm. In a further embodiment, diameter D2 is between 6.0 mm and 8.0 mm and, in a particular embodiment, D2 is 6.0 mm or 8.0 mm depending on the thickness of each of the aluminum alloy workpieces to be joined. Further, spherically domed central region 70 is formed having a radius of curvature between 40.0 mm and 80.0 mm. In one embodiment, spherically domed central region 70 is formed having a radius of curvature between 40.0 mm and 50.0 mm. In a further embodiment, spherically domed central region 70 is formed having a radius of curvature of 50.0 mm.

Annular outer ring 80 is positioned 104 coaxially about spherically domed central region 70. Annular outer ring 80 has end surface 82 defined in plane 84 perpendicular to central axis 56 at distance 90 from point 92 on spherically domed central region 70 defined at central axis 56 dependent on a thickness of each of the aluminum alloy workpieces to be joined. In one embodiment, end surface 82 has a width in plane 84 perpendicular to central axis 56 between 0.50 mm and 2.50 mm.

In one embodiment, during the positioning of annular outer ring 80 coaxially about spherically domed central region 70, annular outer ring 80 is positioned at distance 90 between 0.025 mm and 0.15 mm from point 92 on spherically domed central region 70 at central axis 56. In a particular embodiment, annular outer ring 80 is positioned at distance 90 between 0.050 mm and 0.100 mm from point 92 on spherically domed central region 70 defined at central axis 56.

In certain embodiments, annular channel 94 is formed between the outer boundary of spherically domed central region 70 and inner edge 86 of end surface 82. In these embodiments, annular channel 94 has a width between 0.050 mm and 0.200 mm or, more specifically, between 0.10 mm and 0.15 mm.

In a particular embodiment, with each of the aluminum alloy workpieces having a thickness less than 1.5 mm, spherically domed central region 70 is formed with diameter D2 of 6.0 mm and annular outer ring 80 is positioned less than 0.100 mm from point 92 on spherically domed central region 70 defined at central axis 56. In a further embodiment, annular outer ring 80 is positioned 0.050 mm from point 92 on spherically domed central region 70 defined at central axis 56.

In an alternative embodiment, with each of the aluminum alloy workpieces having a thickness greater than 1.5 mm, spherically domed central region 70 is formed with diameter D2 of 8.0 mm and annular outer ring 80 is positioned less than 0.250 mm from point 92 on spherically domed central region 70 defined at central axis 56. In a further embodiment, annular outer ring 80 is positioned 0.100 mm from point 92 on spherically domed central region 70 defined at central axis 56.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended the scope be defined by the claims appended hereto. Additionally, the features of various implementing embodiments may be combined to form further embodiments.

What is claimed is:

1. An electrical resistance spot welding tip for joining a plurality of aluminum alloy workpieces, the electrical resistance spot welding tip comprising:
a cylindrical body extending along a central axis defined through the body between a first end and an opposing second end of the cylindrical body;
a spherically domed central region formed at the first end of the cylindrical body, the spherically domed central region having an outer boundary defining a diameter of the spherically domed central region; and
an annular outer ring positioned coaxially about the spherically domed central region, the annular outer ring having an end surface defined in a plane perpendicular to the central axis,
wherein a distance along the central axis between a point on the spherically domed central region defined at the central axis and the end surface of the annular outer ring is dependent on a thickness of each of the plurality of aluminum alloy workpieces.

2. The electrical resistance spot welding tip of claim 1, wherein the distance between the point on the spherically domed central region defined at the central axis and the end surface of the annular outer ring is between 0.025 mm and 0.15 mm.

3. The electrical resistance spot welding tip of claim 1, wherein the distance between the point on the spherically domed central region defined at the central axis and the end surface of the annular outer ring is between 0.050 mm and 0.100 mm.

4. The electrical resistance spot welding tip of claim 1, wherein the diameter of the spherically domed central region is defined by a circumferential wall forming the outer boundary.

5. The electrical resistance spot welding tip of claim 1, wherein the diameter of the spherically domed central region is between 4.0 mm and 10.0 mm.

6. The electrical resistance spot welding tip of claim 1, wherein the diameter of the spherically domed central region is between 6.0 mm and 8.0 mm.

7. The electrical resistance spot welding tip of claim 1, wherein with each of the aluminum alloy workpieces having a thickness less than 1.5 mm, the diameter of the spherically domed central region is 6.0 mm and the distance between the point on the spherically domed central region defined at the central axis and the end surface of the annular outer ring is less than 0.100 mm.

8. The electrical resistance spot welding tip of claim 7, wherein the distance between the point on the spherically domed central region defined at the central axis and the end surface of the annular outer ring is 0.050 mm.

9. The electrical resistance spot welding tip of claim 1, wherein with each of the aluminum alloy workpieces having a thickness greater than 1.5 mm, the diameter of the spherically domed central region is 8.0 mm and the distance between the point on the spherically domed central region defined at the central axis and the end surface of the annular outer ring is less than 0.250 mm.

10. The electrical resistance spot welding tip of claim 9, wherein the distance between the point on the spherically domed central region defined at the central axis and the end surface of the annular outer ring is 0.100 mm.

11. The electrical resistance spot welding tip of claim 1, wherein the spherically domed central region has a radius of curvature between 40.0 mm and 80.0 mm.

12. The electrical resistance spot welding tip of claim 1, wherein the spherically domed central region has a radius of curvature of 50.0 mm.

13. The electrical resistance spot welding tip of claim 1, wherein the end surface has a width in the plane perpendicular to the central axis of between 0.50 mm and 2.50 mm.

14. The electrical resistance spot welding tip of claim 1, further comprising an annular channel formed between the outer boundary of the spherically domed central region and the end surface.

15. The electrical resistance spot welding tip of claim 14, wherein the annular channel has a width between 0.050 mm and 0.200 mm.

16. The electrical resistance spot welding tip of claim 1, wherein the cylindrical body has an outer diameter between 18.00 mm and 20.0 mm.

17. An electrical resistance spot welding electrode for joining a plurality of aluminum alloy workpieces, the electrical resistance spot welding electrode comprising:
a welding tip having a cylindrical body extending along a central axis defined through the cylindrical body between a first end and an opposing second end of the cylindrical body;
a spherically domed central region formed at the first end of the cylindrical body, the spherically domed central region having an outer boundary defining a diameter of the spherically domed central region; and
an annular outer ring positioned coaxially about the spherically domed central region, the annular outer ring having an end surface defined in a plane perpendicular to the central axis,
wherein a distance along the central axis between a point on the spherically domed central region defined at the central axis and the end surface of the annular outer ring is dependent on a thickness of each of the plurality of aluminum alloy workpieces.

18. The electrical resistance spot welding electrode of claim 17, further comprising an annular channel formed between the outer boundary of the spherically domed central region and the end surface.

19. The electrical resistance spot welding electrode of claim 17, wherein the distance between the point on the spherically domed central region defined at the central axis and the end surface of the annular outer ring is between 0.025 mm and 0.15 mm.

20. A method for making an electrical resistance spot welding tip for joining a plurality of aluminum alloy workpieces, the method comprising:
forming a spherically domed central region at a first end of a cylindrical body extending along a central axis defined through the cylindrical body between the first end and an opposing second end of the cylindrical body; and
positioning an annular outer ring coaxially about the spherically domed central region, the annular outer ring having an end surface defined in a plane perpendicular to the central axis, at a distance along the central axis from a point on the spherically domed central region defined at the central axis dependent on a thickness of each of the plurality of aluminum alloy workpieces.
